(19) United States
(12) Patent Application Publication
(10) Pub. No.: US 2009/0122786 A1
(43) Pub. Date: May 14, 2009

(54) SIGNALING METHOD IN IP TELEPHONE SYSTEM , IP TELEPHONE SYSTEM, AND IP TELEPHONE DEVICE

(75) Inventors: Hsueh-Teng Liu, Taipei (TW); Hui-Yeen Chen, Taipei (TW)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/911,302

(22) PCT Filed: Apr. 15, 2005
(86) PCT No.: PCT/JP2005/007335

§ 371 Date: Oct. 11, 2007

(51) Int. Cl. H04L 12/66

(52) U.S. Cl. 370/352

(57) ABSTRACT

There is provided a signaling method for an IP telephony system (1) including a call terminal (10), a destination terminal having its identifier (20) and an extension terminal (30a) having its identifier and correlated to the destination terminal (20). A message having a header portion indicating the identifier of the destination terminal (20) and a payload portion indicating the identifier of the extension terminal (30a) is transmitted from the call terminal (10) to the destination terminal (20). The message transmitted is transferred from the destination terminal (20) to the extension terminal (30a). A response signal to the transferred message is returned from the extension terminal (30a) to the destination terminal (20).

### TECHNICAL FIELD

The present invention relates to a signaling method in an IP (Internet Protocol) telephone system, IP telephone system and IP telephone apparatus.

### BACKGROUND ART

Up till now, a method for executing call signaling to a destination terminal and extension terminal has been considered in telecommunication systems such as an IP telephone system and key telephone system using VoIP (Voice over Internet Protocol).

For example, with the method disclosed in Patent Document 1, call signaling to a telecommunication system is executed through signaling channel, and after call signaling is successfully performed, the entered extension number is converted into corresponding DTMF (dual-tone multi-frequency) signals and transmitted through a voice channel, and then the telecommunication system, interpreting the DTMF signals, issues another signaling message and signaling to an extension terminal is finished.

In addition, with the method disclosed in Patent Document 2, the establishment processing of a communication path is started by issuing a signal representing a telephone number, and, if the condition for issuing the signal representing the extension number is satisfied, DTMF signals representing an extension number are issued to the destination terminal, and then, the destination terminal issues another signaling message representing an extension number and signaling to an extension terminal is finished.

Patent Document 1: U.S. Pat. No. 6,459,785.
Patent Document 2: U.S. Pat. No. 6,546,083

### DISCLOSURE OF INVENTION

### Problems to be Solved by the Invention

The method of signaling in the above-described prior art performs signaling in two steps: signaling to the destination terminal is performed at the first step and signaling to an extension terminal is performed at the second step. Further, in the first step, after a signaling message containing the telephone number of the destination terminal is sent through a signaling channel, DTMF signals representing the extension number of an extension terminal are transmitted through voice channel. Requesting user operations in the above steps is inconvenient and there is another problem that it takes long time until signaling to extension terminal is finished.

It is therefore an object of the present invention to provide a signaling method in an IP (Internet Protocol) telephone system, IP telephone system and IP telephone apparatus that can simplify the terminal operation upon call and reduce the time required for call signaling to an extension terminal.

### Means for Solving the Problem

A signaling method in an internet protocol telephone system having an origination terminal, a destination terminal having identity information, and an extension terminal having identity information and being associated with the destination terminal, the method of the present invention employs a configuration having the steps of: transmitting a message having a header part representing identity information of the destination terminal and a payload part representing identity information of the payload part, from the origination terminal to the destination terminal; forwarding the transmitted message from the destination terminal to the extension terminal; and returning a acknowledgement signal in response to the forwarded message from the extension terminal to the destination terminal.

A signaling method in an internet protocol telephone system having an origination terminal, a destination terminal having identity information, and a plurality of extension terminals having identity information and being associated with the destination terminal, the method of the present invention employs a configuration having the steps of: transmitting a message having a header part representing identity information of the destination terminal and a payload part representing identity information of each of the plurality of extension terminals and a priority order of the plurality of extension terminals, from the origination terminal to the destination terminal; forwarding the transmitted message from the destination terminal to a first extension terminal among the plurality of extension terminals, according to the priority order; returning a first acknowledgement signal from the first extension terminal to the destination terminal, the first acknowledgement signal being in response to the message forwarded to the first extension terminal and representing a rejection of call establishment; forwarding the transmitted message from the destination terminal to a second extension terminal among the plurality of extension terminals, according to the priority order, after the first acknowledgement signal is returned; and returning a second acknowledgement signal in response to the message forwarded to the second extension terminal from the second extension terminal to the destination terminal.

An internet protocol telephone system of the present invention having an origination terminal, a destination terminal having identity information, and an extension terminal having identity information and being associated with the destination terminal, the system employs a configuration wherein: the origination terminal transmits a message having a header part representing identity information of the destination terminal and a payload part representing identity information of the payload part to the destination terminal; the destination terminal forwards the message transmitted from the origination terminal to the extension terminal; and the extension terminal returns a acknowledgement signal in response to the message forwarded from the destination terminal to the destination terminal

An internet protocol telephone system of the present invention having an origination terminal, a destination terminal having identity information, and a plurality of extension terminals having identity information and being associated with the destination terminal, the system employs a configuration wherein: the origination terminal transmits a message having a header part representing identity information of the destination terminal and a payload part representing identity information of the payload part, to the destination terminal; the destination terminal forwards the message transmitted from the origination terminal to the plurality of extension terminals according to the priority order; and the plurality of extension terminals returns a acknowledgement signal in response to the message forwarded from the destination terminal, to the destination terminal.

An internet protocol telephone apparatus of the present invention employs a configuration having: an obtaining section that obtains identity information of a destination terminal and identity information of an extension terminal; a generating section that generates a message having a header part representing identity information of the destination terminal and a payload part representing identity information of the payload part; and a transmitting section that transmits the message generated in the generating section to the destination terminal.

An internet protocol telephone apparatus of the present invention having identity information, employs a configuration having: a receiving section that receives a message having a header part representing the identity information, from an origination terminal; a deciding section that decides whether or not there is a payload part representing identity information of extension terminal in the message received in the receiving section; and a forwarding section that forwards the message to the extension terminal specified by the identity information shown in the payload section, when payload is decided to be present in the message

An internet protocol telephone apparatus of the present invention having identity information and associated with a destination terminal receiving a message from an origination terminal, the apparatus employs a configuration having: a receiving section that receives the message transmitted from the origination terminal to the destination terminal and forwarded from the destination terminal, the message having a header part representing the identity information of the destination terminal and a payload part representing the identity information of the internet protocol telephone apparatus; and a returning section that returns the acknowledgement signal in response to the message received by the receiving section to the destination terminal.

### ADVANTAGEOUS EFFECT OF THE INVENTION

According to the present invention, it is possible to simplify the terminal operation upon call and reduce the time required for call signaling to an extension terminal.

### BRIEF DESCRIPTION OF DRAWINGS

FIG. 1 illustrates a configuration of an IP telephone system according to Embodiment 1 of the present invention;

FIG. 2 is a block diagram showing a configuration of an IP telephone apparatus being an origination terminal according to Embodiment 1 of the present invention;

FIG. 3 is a block diagram showing a configuration of an IP telephone apparatus being a destination terminal according to Embodiment 1 of the present invention;

FIG. 4 is a block diagram showing IP telephone apparatus being an extension terminal according to Embodiment 1 of the present invention;

FIG. 5 is a flowchart showing an operation of an IP telephone apparatus being a destination terminal according to Embodiment 1 of the present invention;

FIG. 6 is a flowchart showing an operation of an IP telephone apparatus being a destination terminal according to Embodiment 1 of the present invention;

FIG. 7 is a flowchart showing an operation of an IP telephone apparatus being an extension terminal according to Embodiment 1 of the present invention;

FIG. 8 illustrates INVITE message according to Embodiment 1 of the present invention;

FIG. 9 illustrates a diagram showing a sequence of signaling in an IP telephone system according to Embodiment 1 of the present invention;

FIG. 10 is a flowchart showing an operation of an IP telephone apparatus being an origination terminal according to Embodiment 2 of the present invention; and

FIG. 11 is a flowchart showing an operation of an IP telephone apparatus being an extension terminal according to Embodiment 2 of the present invention.

### BEST MODE FOR CARRYING OUT THE INVENTION

Embodiments of the present invention will be described below in detail with reference to the accompanying drawings.

### Embodiment 1

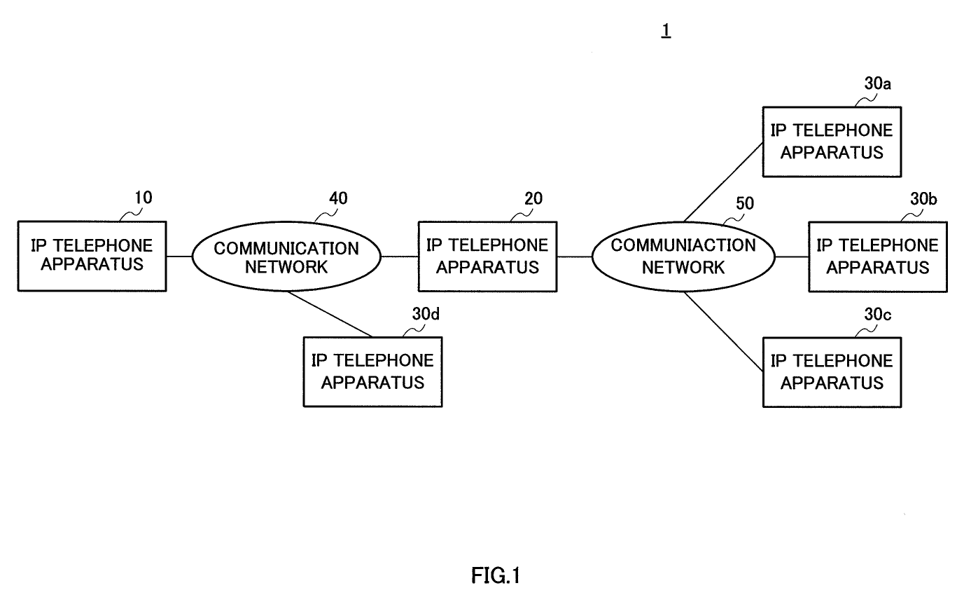

FIG. 1 illustrates the configuration of an IP telephone system according to Embodiment 1 of the present invention. IP telephone system 1 of FIG. 1 is a SIP (Session Initiation Protocol)-based system and is comprised from a plurality of IP telephone apparatuses 10, 20, 30a, 30b, 30c and 30d and communication networks 40 and 50. IP telephone apparatuses 10, 20 and 30d are connected to communication network 40. IP telephone apparatuses 20, 30a, 30b and 30c are connected to communication network 50.

For ease of understanding of the following explanation, in the present embodiment, IP telephone apparatus 10 operates as an origination terminal that makes a call (VoIP call), IP telephone apparatus 20 operates as a destination terminal of the call made by the origination terminal and IP telephone apparatuses 30a, 30b, 30c and 30d operate as an extension terminal associated with a destination terminal.

IP telephone apparatus 10 is an origination terminal and has unique VoIP identity information such as a telephone number and URI (Uniform Resource Identifier). Further, IP telephone apparatus 10 employs the configuration for making the VoIP call. The identity information of an origination terminal will be referred to as the “origination ID”. The configuration of IP telephone apparatus 10 will be described in detail later.

IP telephone apparatus 20 is a destination terminal and has unique VoIP identity information such as a telephone number and URI. Further, IP telephone apparatus 20 employs the configuration for receiving the VoIP call made. The VoIP identity information of a destination terminal will be referred to as the “destination ID”. The configuration of IP telephone apparatus 20 will be described in detail later.

IP telephone apparatuses 30a, 30b, 30c and 30d are extension terminals, have extension identity information and are associated with IP telephone apparatus 20 being the destination terminal. The identity information of an extension terminal will be referred to as “extension ID”. The internal configuration of IP telephone apparatuses 30a, 30b, 30c and 30d will be described in detail later. Further, IP telephone apparatus 30d is a roaming extension terminal.

IP telephone apparatus 10 may employ the configuration of a destination terminal or an extension terminal in addition to the configuration of an origination terminal. IP telephone apparatus 20 may employ the configuration of an origination terminal and an extension terminal in addition to the configuration of a destination terminal. IP telephone apparatus 30a, 30b, 30c and 30d may employ the configuration of an origination terminal and a destination terminal in addition to the configuration of an extension terminal. IP telephone apparatuses 10, 20, 30a, 30b, 30c and 30d may be fixed-line telephone apparatuses or mobile communication terminals such as mobile phones.

Communication network 40 may be the Internet, IP network, IP wireless network or IP mobile network. Communication network 50 may be private network, home network, IP network or IP wireless network.

The configurations of IP telephone apparatus 10 being an origination terminal, IP telephone apparatus 20 being a destination terminal and IP telephone apparatus 30a being an extension terminal, will be described in order. Here, configurations of IP telephone apparatus 30b, 30c and 30d are the same as the configuration of IP telephone apparatus 30a and the explanation thereof will be omitted.

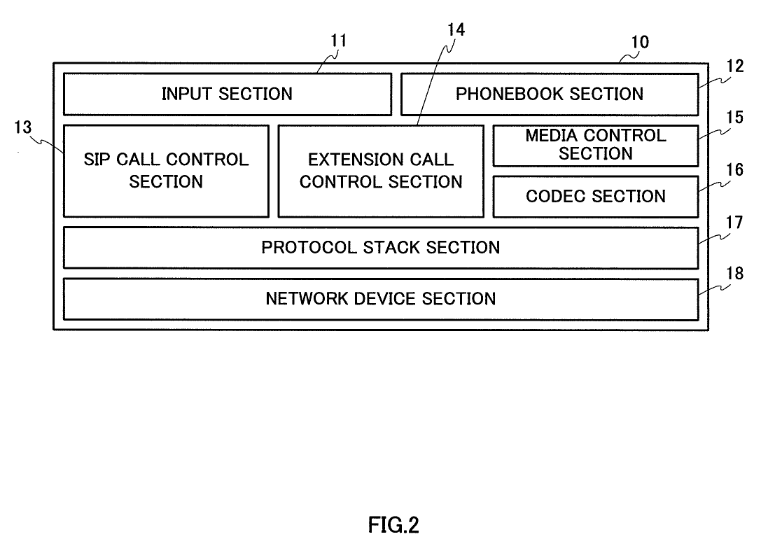

As shown in FIG. 2, IP telephone apparatus 10 has input section 11, phonebook section 12, SIP call control section 13, extension call control section 14, media control section 15, codec section 16, protocol stack section 17 and network device section 18.

Input section 11 inputs a character string representing a destination ID (hereinafter simply “destination ID”) and a character string representing an extension ID (hereinafter simply “extension ID”). This input is executed according to, for example, user operation. Further, input section 11 may employ the configuration where information inputted by user operation is converted into a destination ID or extension ID.

Phonebook section 12 stores a phonebook including destination IDs and extension IDs in advance. Further, phonebook section 12 searches for destination IDs and extension IDs. Search for destination IDs and extension IDs are executed according to, for example, user operation.

SIP call control section 13 is a function block for SIP-based call control and processes SIP-based VoIP signaling message (SIP signaling message).

Extension call control section 14 constructs extension ID information payload assembled into an INVITE message being one of SIP signaling messages and assembles the created payload into the INVITE message.

Media control section 15 generates transport messages from VoIP media packets (for example, packetized voice data, paketized video data and packetized image data), and generates the packetized voice data, the paketized video data and the packetized image data from VoIP media packets.

Codec section 16 packetizes analog video, image and voice into VoIP media packets, and decodes the analog video, image and voice from VoIP media packets.

Protocol stack section 17 is a function block corresponding to a protocol stack including TCP (Transmission Control Protocol), UDP (User Datagram Protocol) and IP, and receives VoIP signaling messages and transport messages through network device section 18. Here, IP could be IPv4, IPv6 or IPv4-IPv6 dual mode.

Network device section 18 is a function block for physical layer and could be IEEE 802.3 Ethernet network device (registered trademark), IEEE 802.3 series wireless LAN network device or a Bluetooth (registered trademark) network device.

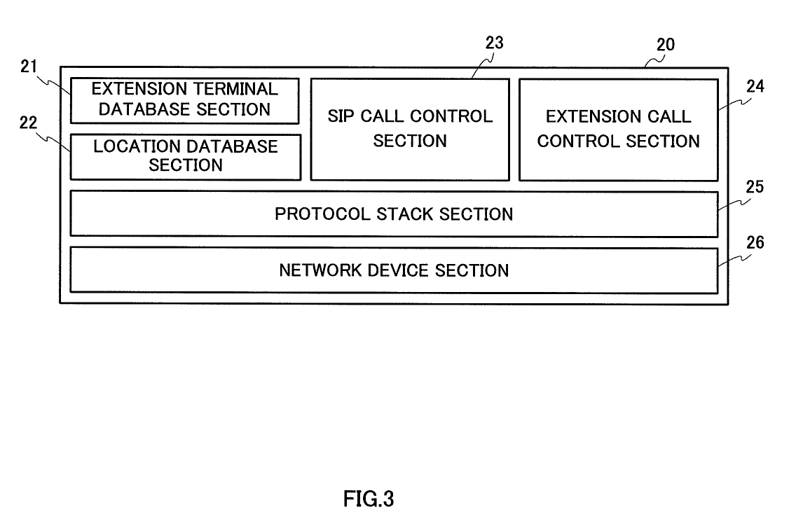

As shown in FIG. 3, IP telephone apparatus 20 has extension terminal database section 21, location database section 22, SIP call control section 23, extension call control section 24, protocol stack section 25 and network device section 26.

Extension terminal database section 21 registers all existing extension terminals (IP telephone apparatuses 30a, 30b, 30c and 30d in the present embodiment) in an internal database. Further, extension terminal database section 21 stores and manages, for example, the extension ID of each extension terminal in the storage area of internal extension terminal database section 21 as presence information.

Location database section 22 stores and manages current address information of registered extension terminals in the storage area inside location database section 22.

SIP call control section 23 is a function block for SIP-based call control and processes SIP signaling messages.

Extension call control section 24 parses and processes extension ID information payload assembled into an INVITE message.

Protocol stack section 25 is a function block corresponding to protocol stack including TCP, UDP and IP and receives signaling messages and transport messages through network device section 26. Here, IP could be IPv4, IPv6 or IPv4-IPv6 dual mode.

Network device section 26 is a function block corresponding to a physical layer, such as IEEE 802.3 Ethernet network device (registered trademark), IEEE 802.3 series wireless LAN network device and a Bluetooth (registered trademark) network device.

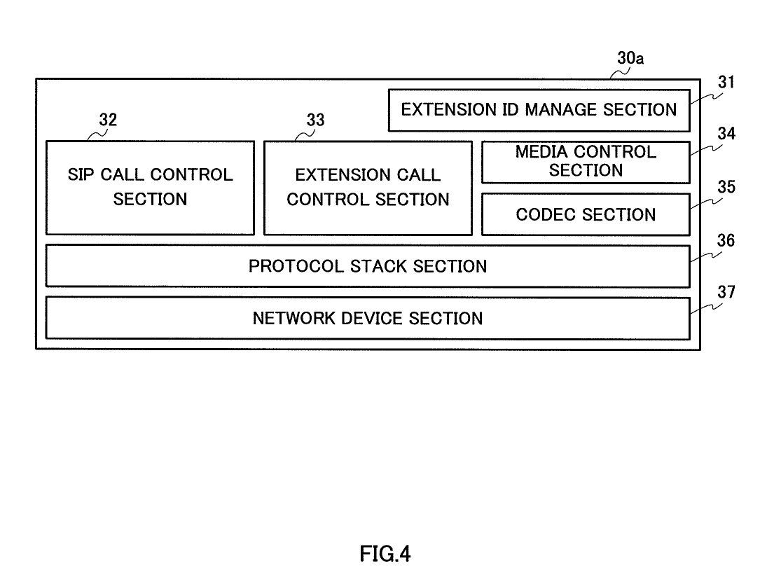

As shown in FIG. 4, IP telephone apparatus 30a has extension ID manage section 31, SIP call control section 32, extension call control section 33, media control section 34, codec section 35, protocol stack section 36 and network device section 37.

Extension ID manage section 31 stores and manages the extension ID of IP telephone apparatus 30a itself in a storage area inside extension ID manage section 31.

SIP call control section 32 is a function block for SIP-based call control and processes SIP signaling messages.

Extension call control section 33 parses and processes extension ID information payload assembled into an INVITE message.

Media control section 34 assembles VoIP media packets into transport messages and generates VoIP media packets from the transport messages.

Codec section 35 packetizes analog video, image and voice into the VoIP media packet and decodes the analog video, image and voice from VoIP media packet.

Protocol stack section 36 is a protocol block corresponding to a protocol stack including TCP, UDP and IP and receives signaling messages and transport messages through network device section 37. Here, IP could be IPv4, IPv6 or IPv4-IPv6 dual mode.

Network device section 37 is a function block corresponding to a physical layer, such as IEEE 802.3 Ethernet network device (registered trademark), IEEE 802.3 series wireless LAN network device and a Bluetooth (registered trademark) network device.

Next, the operation of origination terminal, destination terminal and extension terminal in each IP telephone apparatus will be described in order.

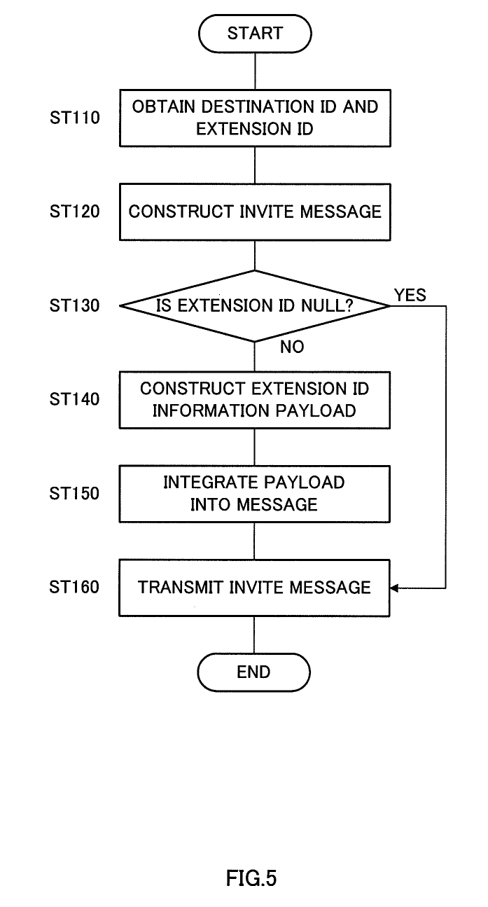

FIG. 5 is a flowchart showing an example of the operation of IP telephone apparatus 10 being an origination terminal.

At step 110, both a destination ID and extension ID are obtained. For example, when the destination ID of an IP telephone apparatus, associated with another IP telephone apparatus as an extension terminal, is inputted to input section 11, or when the destination ID is searched for by phonebook section 12, the combination of the destination ID and the extension ID is obtained.

At step ST120, SIP call control section 13 temporarily constructs an INVITE message. The temporarily constructed INVITE message includes a SIP header containing signaling information such as an origination ID and destination ID, and a SDP (Session Description Protocol) payload containing media session attributes.

At step ST130, whether or not the obtained extension ID is null is decided. If the extension ID is not null, in other words, if there is an extension terminal associated with the destination terminal specified by the extension ID (ST130: NO), the flow proceeds to step ST140, and, if the extension ID is null, in other words, if there is not an extension terminal associated with the destination terminal specified by the extension ID (ST130: YES), the flow proceeds to step ST160.

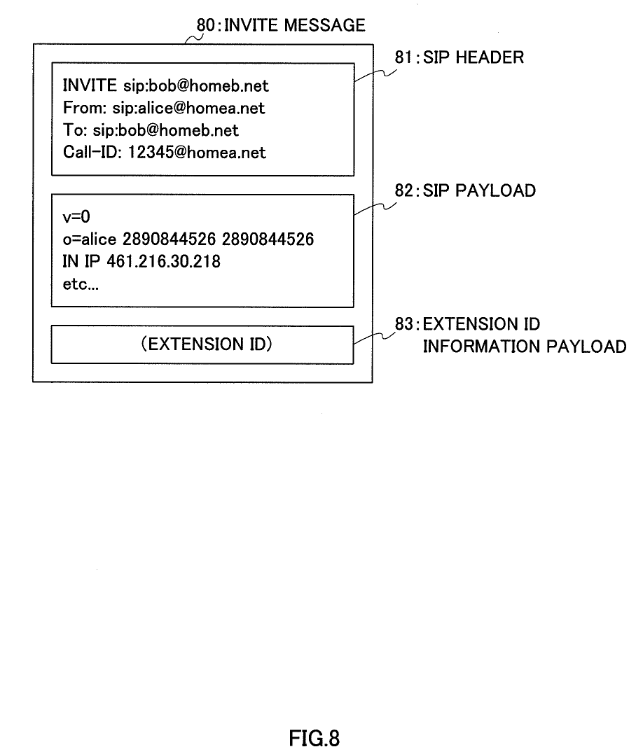

At step ST140, extension ID information payload is constructed into a MIME (Multipurpose Internet Mail Extensions) format. At step ST150, extension ID information payload is assembled into the temporarily constructed INVITE message, and, as shown in FIG. 8, an INVITE message, having SIP header 81 containing a plurality of fields representing an origination ID and destination ID, SDP payload 82, and extension ID information payload 83 representing an extension ID, is completed. As described above, the INVITE message is completed by assembling extension ID information payload into the temporarily constructed INVITE message, so that it is possible to use the INVITE message without making complicated changes to the existing message format and make it easy to introduce the INVITE message into a system.

At step ST160, the INVITE message constructed at step ST120 or step ST150 is encapsulated and the encapsulated INVITE message is transmitted from network device section 18 to a destination terminal.

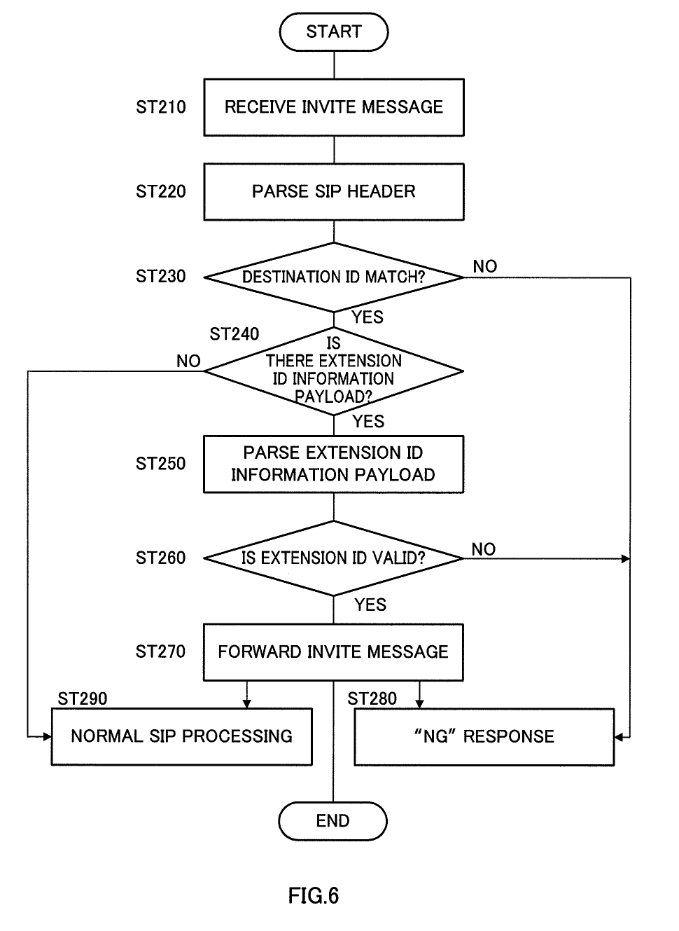

FIG. 6 is a flowchart showing an example of the operation of IP telephone apparatus 20 being a destination terminal.

First, at step ST210, the INVITE message transmitted from an origination terminal is received in network device section 26, de-encapsulated in protocol stack section 25, and processed in SIP call control section 23.

At step ST220, in SIP call control section 23, the SIP header of the INVITE message is parsed and the destination ID is obtained.

At step ST230, whether or not the destination ID matches the identity information of IP telephone apparatus 20 is decided. As a result of the decision, if the obtained destination ID matches the identity information of IP telephone apparatus 20 (ST230: YES), the flow proceeds to step ST240, and, if the obtained destination ID does not match the identity information of IP telephone apparatus 20 (ST230: NO), the flow proceeds to step ST280.

At step ST240, whether or not there is extension ID payload in the received INVITE message is decided. As a result of the decision, if there is the extension ID information payload in the INVITE message (ST240: YES), the flow proceeds to step ST 250, and, if there is not the extension ID information payload in the INVITE message (ST240: NO), the flow proceeds to step ST290.

At step ST250, the extension ID information payload is parsed and an extension ID is obtained. At step ST260, whether or not the obtained extension ID is valid is decided. Specifically, by deciding whether or not the obtained extension ID matches the extension ID of one of all extension terminals registered in extension terminal database section 21, the validity of the obtained extension ID is decided. As a result of the decision, if the obtained extension ID is valid (ST260: YES), the flow proceeds to step ST 270, and, if the obtained extension ID is invalid (ST260: NO), the flow proceeds to step ST280.

At step ST270, the INVITE message received from the origination terminal is prepared as a to-be-forwarded message to the extension terminal specified by the obtained extension ID and is forwarded to the extension terminal.

At step ST280, the acknowledgement signal representing NG, that is, the rejection of call establishment is transmitted from IP telephone apparatus 20 to the origination terminal.

At step ST290, normal SIP-based call processing is performed. In this case, a call is established between IP telephone apparatus 20 and the origination terminal.

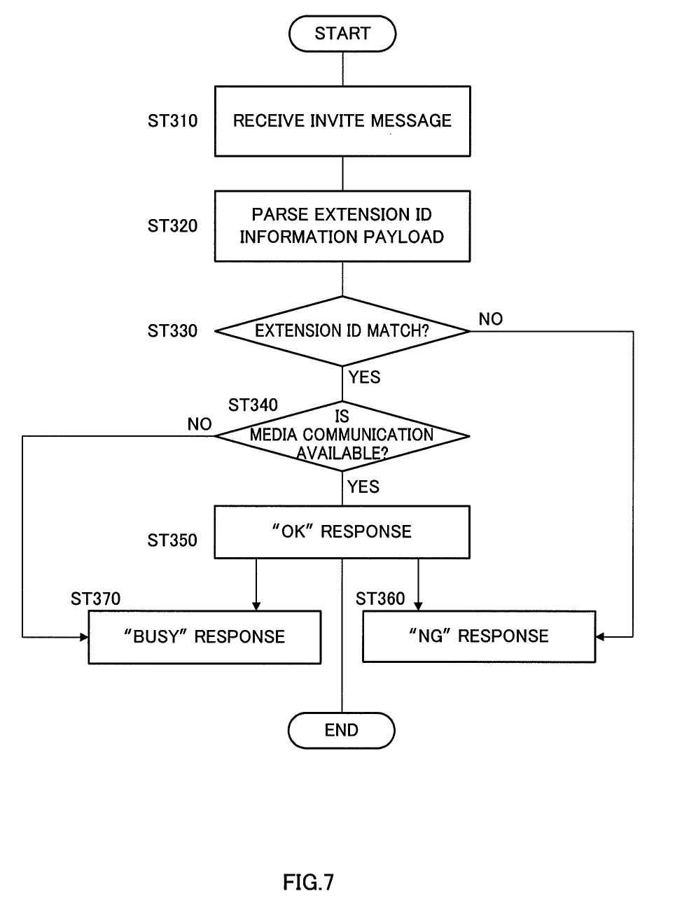

FIG. 7 is a flowchart showing an example of the operation of IP telephone apparatus 30a being an extension terminal.

First, at step ST310, the INVITE message, forwarded from a destination terminal as the forwarded message, is received and processed in SIP call control section 32.

At step ST320, the extension ID information payload included in the received INVITE message is parsed and the extension ID is obtained.

At step ST 330, whether or not the obtained extension ID matches the extension ID stored in extension ID manage section 31, is decided. As a result of the decision, if the obtained extension ID matches the extension ID stored in extension ID manage section 31 (ST330: YES), the flow proceeds to step ST340, and, if the obtained extension ID does not match the extension ID stored in extension ID manage section 31 (ST330: NO), the flow proceeds to step ST360.

At step ST340, whether or not media communication for performing processing is available for media control section 34, is decided. As a result of the decision, if media communication is available (ST340: YES), the flow proceeds to step ST350, and, if media communication is not available (ST340: NO), the flow proceeds to step ST370.

At step ST350, a acknowledgement signal representing “OK” is transmitted to a destination terminal for reporting the availability of call establishment to the destination terminal. In this case, a call is established between the origination terminal and the destination terminal.

At step ST360, a acknowledgement signal representing “NG” is transmitted to the destination terminal for reporting a rejection of call establishment to the destination terminal.

At step ST370, a acknowledgement signal representing “busy” is transmitted to the destination terminal for reporting the unavailability of media communication to the destination terminal

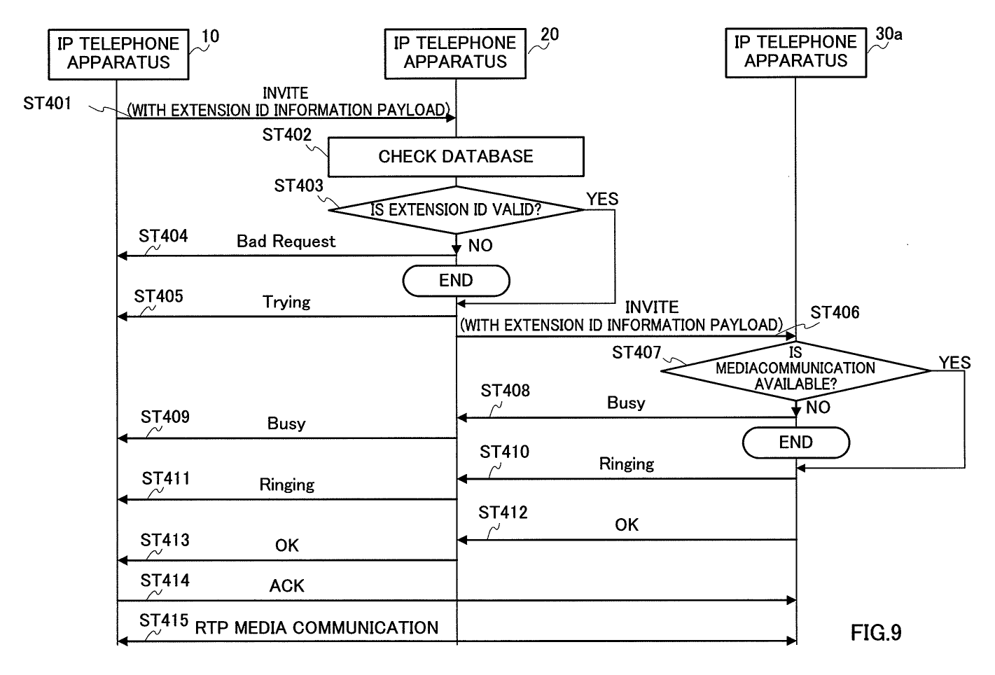

Next, an example of signaling sequence of IP telephone system 1 will be described using FIG. 9. A case will be described here where IP telephone apparatus 10 operates as an origination terminal, IP telephone apparatus 20 operates as a destination terminal and IP telephone apparatus 30a operates as an extension terminal.

First, an INVITE message having extension ID information payload is transmitted from IP telephone 10 to IP telephone apparatus 20 (step ST401). IP telephone apparatus 20 receiving the INVITE message obtains the extension ID represented by the extension ID information payload. Further, IP telephone apparatus 20 checks presence information stored in extension terminal database section 21 (step ST402) and decides the validity of the obtained extension ID (step ST403).

If the extension ID is invalid (ST403: NO), a bad request message, which is one of SIP signaling messages, is transmitted from IP telephone apparatus 20 to IP telephone apparatus 10 and signaling sequence ends without a need to start RTP (Real-time Transport Protocol) media communication.

By contrast, if the extension ID is valid (ST403: YES), a trying message, which is one of SIP signaling messages, is transmitted from IP telephone apparatus 20 to IP telephone apparatus 10 (step ST405) Further, the INVITE message having extension ID information payload is forwarded from IP telephone apparatus 20 to IP telephone apparatus 30a (step ST406).

IP telephone apparatus 30a receiving the INVITE message confirms that the extension ID represented by the extension ID information payload is the extension ID of IP telephone apparatus 30a, and then decides whether or not media communication is available (step ST407).

If media communication is not available (ST407: NO), a busy message, which is one of SIP signaling messages, is transmitted from IP telephone apparatus 30a to IP telephone apparatus 20 (step ST408). IP telephone apparatus 20 receiving the busy message, transmits the busy message to IP telephone apparatus 10 (step ST409). In this case, signaling sequence ends without a need to start RTP media communication.

By contrast, if media communication is available (ST407: YES), a ringing message being one of SIP signaling messages is transmitted from IP telephone apparatus 30a to IP telephone apparatus 20 (step ST410), and further transmitted from IP telephone apparatus 20 to IP telephone apparatus 10 (step ST411).

An OK message being one of SIP signaling messages is transmitted from IP telephone apparatus 30a to IP telephone 20 (step ST412), and further transmitted from IP telephone apparatus 20 to IP telephone apparatus 10 (step ST413).

IP telephone apparatus 10 receiving the OK message, transmits an ACK message being a SIP signaling message to confirm a media session using positive acknowledgement to IP telephone apparatus 30a (step ST414). Then, RTP media communication starts between IP telephone apparatus 10 and IP telephone apparatus 30a.

With the present embodiment, a case has been described above where an INVITE message having a SIP header and extension ID information payload representing a destination ID and extension ID, respectively, is transmitted from an origination terminal to a destination terminal; the transmitted INVITE message is forwarded from the destination terminal to an extension terminal; and a acknowledgement signal to the forwarded INVITE message is returned from the extension terminal to the destination terminal, so that it is possible to complete VoIP call setup at once without taking a plurality of steps, simplify an operation at terminal upon call and reduce the time required for call signaling to the extension terminal.

Further, according to the present embodiment, it is possible to reduce signaling overhead by representing an extension ID in the payload instead of the header.

Here, although a case has been described with the present embodiment where a SIP-based system is used as an example, the system capable of implementing the present embodiment is not limited to the SIP-based system. Similar to SIP, if the system is based on a protocol using a message having a header and payload for call signaling, it is possible to implement the present invention.

### Embodiment 2

Embodiment 2 of the present invention will be described. With the present embodiment, a case will be described as an example where several extension IDs represented by extension ID information payload are obtained. Therefore, the configuration of IP telephone system and IP telephone apparatus have a basic configuration similar to the configuration explained in Embodiment 1, the same apparatuses or components as those explained in Embodiment 1 are assigned the same reference numerals and detailed explanations thereof will be omitted. The present embodiment differs from Embodiment 1 in a processing operation of IP telephone apparatus 10 representing the origination terminal and processing operation of IP telephone apparatus 20 representing IP telephone apparatus 20.

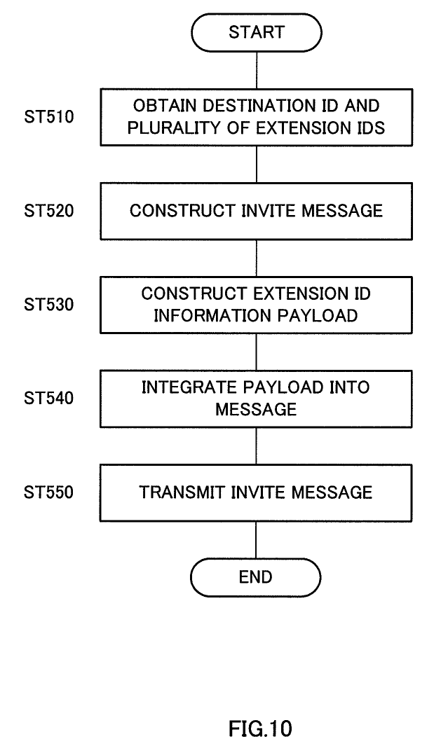

An example of the operation of IP telephone apparatus 10 being an origination terminal, is disclosed in FIG. 10.

First, at step ST510, a destination ID is obtained with a plurality of extension IDs. For example, when a destination ID of an IP telephone apparatus, associated with the other plurality of IP telephone apparatuses as extension terminals, is inputted by input section 11, or when phonebook section 12 searches for the destination ID, the combination of the destination ID and the plurality of extension IDs is obtained.

Here, a priority order of the plurality of extension terminals, specified by the plurality of extension IDs obtained, is determined according to user's (caller's) preference. The priority order is determined according to the priority of each extension terminal. For example, the priority order is determined in order from the highest priority.

At step ST520, an INVITE message is temporarily constructed in SIP call control section 13. The temporarily constructed INVITE message has a SIP header and SDP payload.

At step ST530, extension ID information payload including a plurality of extension IDs is constructed to, for example, a MIME format. The plurality of extension IDs are described according to the priority order, such that, for example, the available extension terminals are displayed in descending order of priority.

At step ST540, the extension ID information payload is assembled into the temporarily constructed INVITE message.

At step ST550, the completed INVITE message is encapsulated in protocol stack section 17 and transmitted from network device section 18 to the destination terminal.

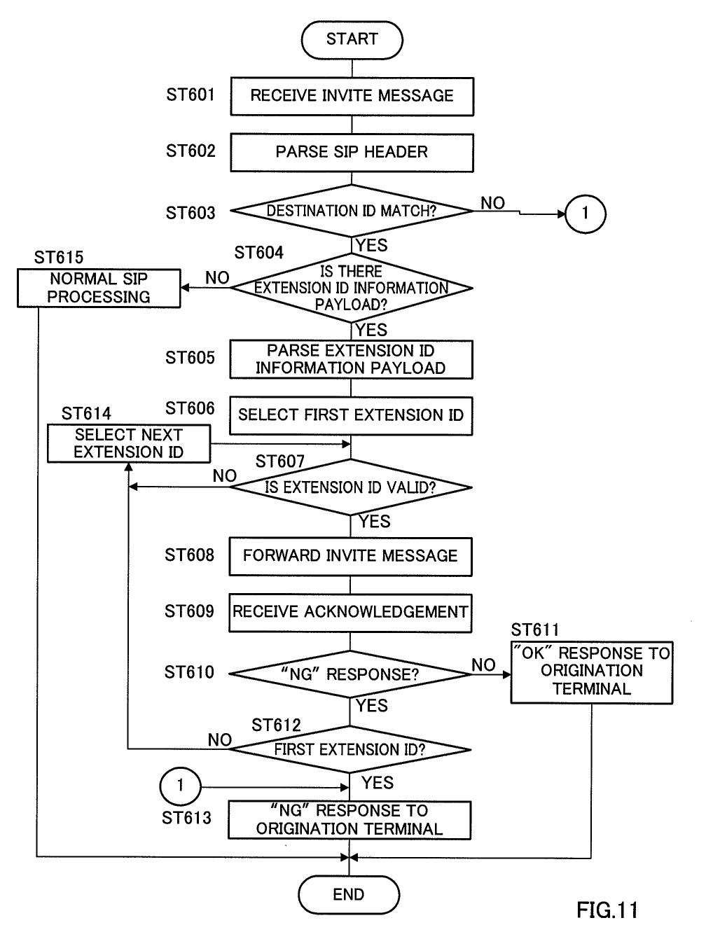

FIG. 11 is a flowchart showing IP telephone apparatus 20 being a destination terminal.

First, at step ST601, the INVITE message transmitted from an origination terminal is received at network device section 26, the received INVITE message is de-encapsulated in protocol stack section 25 and the de-encapsulated INVITE message is processed in SIP call control section 23.

At step ST602, a SIP header of the INVITE message is parsed in SIP call control section 23 and a destination ID is obtained.

At step ST603, whether or not the obtained destination ID matches the identity information of IP telephone apparatus 20. As a result of the decision, if the obtained destination ID matches the identity information of IP telephone apparatus 20 (ST603: YES), the flow proceeds to step ST604, and, if the obtained destination ID does not match the identity information of IP telephone apparatus 20 (ST603: NO), the flow proceeds to step ST613.

At step ST604, whether or not there is extension ID information payload in the received INVITE message is decided. As a result of the decision, if there is extension ID information payload in the received INVITE message (ST604: YES), the flow proceeds to step ST 605, and, if there is not extension ID information payload in the received INVITE message (ST604: NO), the flow proceeds to step ST615.

At step ST605, extension ID information payload is parsed and a plurality of extension IDs are obtained.

At step ST606, the first extension ID is selected from a plurality of obtained extension IDs. The extension ID could be the extension ID of the extension terminal of the highest priority.

At step ST607, whether or not the selected extension ID is valid is decided. Specifically, the validity of the obtained extension ID is determined by deciding whether or not the obtained extension ID matches the extension ID of one of all extension terminals registered in extension terminal database section 21. As a result of the decision, if the obtained extension ID is valid (ST607: YES), the flow proceeds to step ST608, and, if the obtained extension ID is invalid (ST607: NO), the flow proceeds to step ST614.

At step ST608, the INVITE message received from the origination terminal is prepared as a to-be-forwarded message to the extension terminal specified by the obtained extension ID and is forwarded to the extension terminal.

At step ST609, the acknowledgement signal returned from the extension terminal is received. If the received acknowledgement signal does not represent “NG”, in other words, if a acknowledgement signal represents “OK” (ST610: NO), the acknowledgement signal representing “OK” to the origination terminal is transmitted (step ST611), and a call is established between the origination terminal and the extension terminal.

By contrast, if the received acknowledgement signal represents “NG” (ST610: YES), whether or not the presently selected extension ID is the last extension ID is decided (step ST612). If the presently selected extension ID is the last extension ID (ST612: YES), the flow proceeds to step ST613, and, if the presently selected extension ID is not the last extension ID, the flow proceeds to step ST614.

At step ST613, the acknowledgement signal representing “NG” is transmitted to the origination terminal.

At step ST614, the next extension ID is selected from a plurality of obtained extension IDs. In this case, the selected extension ID is, for example, an extension ID of the extension terminal, having a next highest priority to the extension terminal specified by the previously selected extension ID.

At step ST615, SIP-based normal call processing is performed. In this case, a call is established between IP telephone apparatus 20 and the origination terminal.

A case has been described with the embodiment of the present invention where an INVITE message, having a header representing a destination ID and a payload representing a plurality of extension IDs and a priority order of the extension IDs, is transmitted from an origination terminal to a destination terminal: the transmitted INVITE message is forwarded from the destination terminal to the first extension terminal of the plurality of extension terminals, according to the priority order; an NG acknowledgement signal in response to the INVITE message forwarded to the first extension terminal is returned from the first extension terminal to the destination terminal; after the NG acknowledgement signal is returned, the transmitted INVITE message is forwarded from the destination terminal to the second extension terminal of the plurality of extension terminals, according to the priority order; and the acknowledgement signal in response to the INVITE message forwarded to the second extension terminal is returned from the second extension terminal to the destination terminal, so that it is possible to realize the same effects as the previous embodiment, and further complete VoIP call setup at once without taking a plurality of steps, simplify an operation at terminal upon call and reduce the time required for call signaling to the extension terminal even when several extension IDs represented by extension ID information payload is obtained.

Although a case has been described with the present embodiment where a SIP-based system is used as an example, a system that can realize the present invention is not limited to the SIP-based system. Similar to SIP, it is possible to implement the present invention in any systems based on a protocol where messages having a header and payload are used for call signaling.

In the present embodiment, the present invention could be implemented with hardware or software. When the present invention is implemented with software, for example, by describing the signaling method algorithm according to the present invention in a programming language, storing this program in a memory and making the information processing section execute this program.

### INDUSTRIAL APPLICABILITY

The signaling method in an IP telephone system, IP telephone system and IP telephone apparatus of the present invention are useful when call signaling is performed between an origination terminal and a destination terminal or extension terminal.

1. A signaling method in an internet protocol telephone system comprising an origination terminal, a destination terminal having identity information, and an extension terminal having identity information and being associated with the destination terminal, the method comprising the steps of:
transmitting a message having a header part representing identity information of the destination terminal and a payload part representing identity information of the payload part, from the origination terminal to the destination terminal;
forwarding the transmitted message from the destination terminal to the extension terminal; and
returning a acknowledgement signal in response to the forwarded message from the extension terminal to the destination terminal.

2. A signaling method in an internet protocol telephone system comprising an origination terminal, a destination terminal having identity information, and a plurality of extension terminals having identity information and being associated with the destination terminal, the method comprising the steps of:
transmitting a message having a header part representing identity information of the destination terminal and a payload part representing identity information of each of the plurality of extension terminals and a priority order of the plurality of extension terminals, from the origination terminal to the destination terminal;
forwarding the transmitted message from the destination terminal to a first extension terminal among the plurality of extension terminals, according to the priority order;
returning a first acknowledgement signal from the first extension terminal to the destination terminal, the first acknowledgement signal being in response to the message forwarded to the first extension terminal and representing a rejection of call establishment;
forwarding the transmitted message from the destination terminal to a second extension terminal among the plurality of extension terminals, according to the priority order, after the first acknowledgement signal is returned; and
returning a second acknowledgement signal in response to the message forwarded to the second extension terminal from the second extension terminal to the destination terminal.

3. An internet protocol telephone system comprising an origination terminal, a destination terminal having identity information, and an extension terminal having identity information and being associated with the destination terminal, wherein:
the origination terminal transmits a message having a header part representing identity information of the destination terminal and a payload part representing identity information of the payload part to the destination terminal;
the destination terminal forwards the message transmitted from the origination terminal to the extension terminal; and
the extension terminal returns a acknowledgement signal in response to the message forwarded from the destination terminal to the destination terminal

4. An internet protocol telephone system comprising an origination terminal, a destination terminal having identity information, and a plurality of extension terminals having identity information and being associated with the destination terminal, wherein:
the origination terminal transmits a message having a header part representing identity information of the destination terminal and a payload part representing identity information of the payload part, to the destination terminal;
the destination terminal forwards the message transmitted from the origination terminal to the plurality of extension terminals according to the priority order; and
the plurality of extension terminals returns a acknowledgement signal in response to the message forwarded from the destination terminal, to the destination terminal.

5. An internet protocol telephone apparatus, comprising:
an obtaining section that obtains identity information of a destination terminal and identity information of an extension terminal;
a generating section that generates a message having a header part representing identity information of the destination terminal and a payload part representing identity information of the payload part; and
a transmitting section that transmits the message generated in the generating section to the destination terminal.

6. The internet protocol telephone apparatus according to claim 5, further comprising:
a message generating section that generates a message having a header part representing identity information of the destination terminal;
a payload generating section that generates a payload part representing identity information of the extension terminal; and
an adding section that adds the payload part generated in the payload generating section to the message generated in the message generating section.

7. The internet protocol telephone apparatus according to claim 5, wherein the generating section generates a message having a payload part representing identity information of each of a plurality of extension terminals and a priority order of the plurality of extension terminals.

8. The internet protocol telephone apparatus according to claim 7, wherein the generating section generates the payload part showing identity information of each of a plurality of extension terminals in the priority order.

9. An internet protocol telephone apparatus having identity information, comprising:
a receiving section that receives a message having a header part representing the identity information, from an origination terminal;
a deciding section that decides whether or not there is a payload part representing identity information of extension terminal in the message received in the receiving section; and
a forwarding section that forwards the message to the extension terminal specified by the identity information shown in the payload section, when payload is decided to be present in the message.

10. The internet protocol telephone apparatus according to claim 9, further comprising a processing section that performs processing for establishing a call between the internet protocol telephone apparatus and the origination terminal, when the payload part is decided to be present in the message.

11. The internet protocol telephone apparatus according to claim 9, wherein:
the receiving section receives a message, further comprising the payload part representing identity information of each of a plurality of extension terminals and the priority order of the plurality of extension terminals; and
the forwarding section that forwards the message to the plurality of extension terminals specified by the identity information shown in the payload part, according to the priority order.

12. The internet protocol telephone apparatus according to claim 11, wherein:
the priority order is determined by the priority of each of the plurality of extension terminals; and
the forwarding section, at first, forwards the message to the extension terminal having a highest priority among the plurality of extension terminals.

13. The internet protocol telephone apparatus according to claim 11, wherein:
the priority order is determined by the priority of the plurality of extension terminals;
the plurality of extension terminals comprise a first extension terminal and a second extension terminal of lower priority than the first extension terminal, and further comprise a response receiving section that receives a acknowledgement signal transmitted from one of the plurality of extension terminals in response to the message forwarded by the forwarding section; and
the forwarding section, after having forwarded the message to the first extension terminal, forwards the message to the second extension terminal, if the acknowledgement signal that is received in the receiving section and transmitted from the first extension terminal represents a rejection of call establishment.

14. The internet protocol telephone apparatus according to claim 11, wherein:
the priority order is determined according to the priority of the plurality of extension terminals;
the plurality of extension terminals comprise a first extension terminal and a second terminal, the second terminal having a next highest priority to the first extension terminal, and further comprise a response receiving section that receives a acknowledgement signal transmitted from one of the plurality of extension terminals in response to the message forwarded by the forwarding section; and
the forwarding section, after having forwarded the message to the first extension terminal, forwards the message to the second extension terminal, if the acknowledgement signal that is received in the receiving section and transmitted from the first extension terminal represents a rejection of call establishment.

15. An internet protocol telephone apparatus having identity information and associated with a destination terminal receiving a message from an origination terminal, the apparatus comprising:
a receiving section that receives the message transmitted from the origination terminal to the destination terminal and forwarded from the destination terminal, the message having a header part representing the identity information of the destination terminal and a payload part representing the identity information of the internet protocol telephone apparatus; and
a returning section that returns the acknowledgement signal in response to the message received by the receiving section to the destination terminal.
